(19) United States
(12) Patent Application Publication
(10) Pub. No.: US 2021/0070621 A1
(43) Pub. Date: Mar. 11, 2021

(54) METHOD FOR REDUCING THE CAKING TENDENCY OF POTASSIUM CHLORIDE

(71) Applicant: K+S Aktiengesellschaft, Kassel (DE)

(72) Inventors: Holger Hoppe, Zielitz (DE); Markus Burisch, Klipphausen (DE); Guido Baucke, Schenklengsfeld OT Wippershain (DE); Ludger Waldmann, Telgte (DE)

(73) Assignee: K+S Aktiengesellschaft, Kassel (DE)

(21) Appl. No.: 16/638,539

(22) PCT Filed: Aug. 14, 2018
(86) PCT No.: PCT/DE2018/000242

§ 371 Date: Feb. 12, 2020

(30) Foreign Application Priority Data
Aug. 16, 2017 (DE) 10 2017 007 716.9

(51) Int. Cl. C01D 3/26; C01D 3/04

(52) U.S. Cl. CPC C01D 3/26; C01D 3/04; C01P 2006/20; C01P 2006/80; C01P 2002/60

(57) ABSTRACT

A method is useful for reducing the caking tendency of potassium chloride during storage thereof, wherein caking of the potassium chloride grains is induced in the potassium chloride, the caked potassium chloride is passed to grinding, and the ground potassium chloride is subsequently put into storage.

The present invention relates to a method for reducing the caking tendency of potassium chloride, especially in stored potassium chloride, specifically of potassium chloride stored in sacks, big-bags or as a heap.

As a raw material of the chemical industry, potassium chloride has diverse possibilities for use, including its use as an auxiliary in numerous industrial processes. In the chemical industry, potassium chloride is used, for example, in the production of potash fertilizers, as a raw material for producing potassium compounds utilized industrially, such as potassium hydroxide and potassium carbonate, as an electrolyte in melt flux electrolysis, or as a conductive salt in electroplating. Potassium chloride is employed, moreover, as an additive for foods and in pharmaceutical products.

Potassium chloride is typically extracted in underground mines by conventional mineworking, by solution mining, or by solar evaporation of salt waters. On its extraction, potassium chloride is recovered in a comparatively fine form. The grain size of such a product, such as of a product from the hot leaching process, for example, is typically below 2 mm (d₉₀ value, determined by sieve analysis; i.e., 90 wt % of the particles have a grain size below 2 mm). Depending on its intended use, the potassium chloride is marketed in this fine form or else in a coarse form, in the form, for example, of pellets (d₉₀ value 2 to 5 mm) or compacted granules (d₉₀ value>5 mm). Standard commercial forms are, in particular, potassium chloride with potassium contents of at least 60 wt %, calculated as K₂O, corresponding to a potassium chloride content of at least 95 wt %, and also potassium chloride with a KCl content of at least 98 wt % or at least 99 wt %.

Potassium chloride, as a chemically stable compound, can be kept in principle unlimitedly. As a bulk material, it is usually stored, after having been extracted, in silos or as heaps in warehouses (silo dump). According to grade or form of sale, the product is also stored in packaged form, e.g., in sacks or what are called big-bags. The latter are also referred to as FIBCs (an abbreviation for flexible intermediate bulk containers), and hold typically about 1000 to 1300 liters of bulk material.

It is known that potassium chloride especially during storage exhibits a strong tendency toward caking. Hence it is observed that the particles, hereinafter also grains or potassium chloride grains, of the stored potassium chloride stick together to form large agglomerates. This lowers the free mobility of the potassium chloride grains in the stored product, or capacity of the product to flow freely. At the most extreme, the entire product consolidates. This of course makes the stored or packaged potassium chloride more difficult to manage. It is thought that processes of incipient dissolution and recrystallization are brought about by natural fluctuations in humidity and temperature. During such processes, microdeposits are formed on the grain surfaces, and lead in turn to rigid bridges between the adjacent grains. In practice it is found that the grains coalesce at their contact surfaces.

The caking tendency is affected both by the physical properties of the product and by the conditions of storage. For instance, a strong caking tendency is observed in particular for products whose particle morphology is irregular—for example, crystalline products with nonuniform grain size, or products whose grains possess little compressive strength and abrasion resistance and which, accordingly, contain fine abraded material, and also for fine products. Severe compaction of the product because of high pressures, of the kind occurring in heaps or silos and also in big-bags and stacked sacks, but also moisture from the atmosphere and temperature fluctuations during storage, are conducive to the caking of the stored potassium chloride.

It is fundamentally known practice to reduce the caking tendency of potassium chloride through formulation with what are called anticaking agents, also referred to as free flow aids, and so to enhance its capacity for free flow even after prolonged storage. Examples of anticaking or free flow agents, besides substances with hydrophobizing effect such as fatty acids and fatty acid salts (see, for example, DE 1205060), include inorganic anticaking agents, such as potassium hexacyanoferrate(II), basic magnesium carbonate (magnesium hydroxide carbonate), and silica. The amounts of anticaking agents or free flow aids required, however, are comparatively large and lead to additional costs. It is often necessary, moreover, for unformulated potassium chloride to be placed in interim storage. For a range of applications, such as in potassium chloride for pharmaceutical products, moreover, anticaking agents are not permissible

EP 1022252 describes a method for narrowing the grain spectrum of potassium chloride crystallisates and for improving its capacity for free flow, by adding sodium metaphosphate, during the recovery of the crystallisate, to the aqueous salt solution intended for crystallization. This method enables a reduction to be achieved in the use of anticaking agents or free flow aids.

It has surprisingly been found that the tendency of potassium chloride to cake during storage can be significantly reduced if caked potassium chloride is subjected to grinding in order to deagglomerate the caked fractions. After such grinding, the potassium chloride thus treated has a very much lower tendency to cake during storage than a potassium chloride which has not been passed to such grinding.

The present invention relates accordingly to a method for reducing the caking tendency of potassium chloride during storage thereof, wherein caking of the potassium chloride grains is induced in the potassium chloride, the caked potassium chloride is passed to grinding. and the ground potassium chloride is subsequently put into storage.

The caking of potassium chloride may in principle be induced by any measures known to lead to the caking of the potassium chloride. Caking may be induced, for example, by compressing the potassium chloride, especially at compressive pressures of at least 50 kPa. specifically at compressive pressures in the range from 100 kP to 100 MPa. The time required for inducement of caking is dependent, of course, on the pressure and the temperature, and at the stated pressures and at temperatures of 5 to 50° C. is in general at least 12 h, e.g., in the range from 12 h to 10 d. Another factor conducive to caking is the ingress of moisture, in the form of atmospheric humidity, for example. Caking will generally set in fairly quickly, for example, at a relative atmospheric humidity of at least 50%, especially at least 70%. Caking will be induced in particular when pressure is exerted on the potassium chloride and the ingress of moisture is permitted.

As already explained above, caking occurs particularly when potassium chloride is being stored, as for example on storage in heaps, silos or in packaged form, especially in larger containers, as for example in sacks or so-called big-bags, since the stored potassium chloride is generally subject to relatively high compressive pressures. Accordingly, the present invention relates in particular to a method for reducing the caking tendency of potassium chloride during storage thereof, wherein at least the caked fractions of the stored potassium chloride are passed to grinding and the ground potassium chloride is subsequently put into storage again or mixed with the unground fraction of the stored potassium chloride and put into storage again.

The potassium chloride whose caking tendency is to be reduced may in principle be any solid form of potassium chloride. In the solid forms, the potassium chloride is in a particulate form, the particles being referred to generally as grains. The grains may comprise crystals, or pellets or compacted granules produced from the crystals. The advantage of the invention is manifested particularly for potassium chloride which is in the form of crystals, i.e., the grains of the potassium chloride product are crystals.

The potassium chloride whose caking tendency is to be reduced may in principle be a solid potassium chloride having the grain sizes customary for standard commercial potassium chloride products, where the grain bands are typically in the range from 0.01 to 50 mm. The advantages of the invention are manifested especially for potassium chloride products in which at least 90 wt % of the potassium chloride has a grain size in the range from 0.01 to 5 mm, more particularly in the range from 0.05 to 1 mm, determined by sieve analysis according to DIN 66165:2016-08. The average grain size (weight average or the x_{50,3} value) of the potassium chloride is in the range from 20 μm to 3000 μm, more particularly in the range from 20 μm to 800 μm. Since rational determination of the grain sizes is not possible in the caked potassium chloride, the figures given here relate to the grain sizes of the potassium chloride whose caking tendency is to be reduced, or, in the case of potassium chloride which has already been put into storage, to the grain sizes of the potassium chloride prior to storage, which correspond essentially to the grain sizes in the freshly produced potassium chloride.

The grain sizes reported here and hereinafter are the values as determined by sieve analysis according to DIN 66165:2016-08. According to DIN 66165:2016-08, the mass fractions of the respective grain sizes or grain size ranges are ascertained by fractionating the disperse material using a plurality of sieves, by means of mechanical sieving, in precalibrated systems. Unless otherwise indicated, percentages in connection with particle sizes or grain sizes should be understood as particulars in wt %. In this context, the d₉₀ value or x_{90,3} value refers to the grain size below which 90 wt % of the potassium chloride grains fall. The d₁₀ value or x_{10,3} value denotes the grain size which 10 wt % of the potassium chloride grains fall below. The d₅₀ value or x50,3 value denotes the weight-average grain size. The grain size distribution may also be determined by laser light scattering (laser light diffraction), in accordance with the method specified in ISO 13320:2009, for example, especially in the case of very small particles with particle sizes <200 μm.

The method of the invention is in general suitable for any grades of potassium chloride. Typically a potassium chloride is used which has potassium contents of at least 60 wt %, calculated as K₂O, corresponding to a potassium chloride content of at least 95 wt %. The method of the invention is especially suitable for reducing the caking tendency of potassium chloride having a high KCl content. In particular, such a potassium chloride has a KCl content of at least 98.0 wt %, e.g., in the range from 98.0 to 99.9 wt %, especially at least 98.5 wt %, e.g., in the range from 98.5 to 99.9 wt %, especially at least 99,0 wt %, e.g., in the range from 99.0 to 99.9 wt %, based in each case on the nonaqueous constituents of the potassium chloride. Besides KCl, the potassium chloride may also comprise other constituents, different from potassium chloride and water. These constituents more particularly are sodium chloride, bromides of sodium or of potassium, or alkaline earth metal halides such as magnesium chloride and calcium chloride, and their oxides. The total amount of such constituents will generally not exceed 2.0 wt o, more particularly 1.5 wt % and especially 1.0 wt %, and is situated typically in the range from 0.1 to 2.0 wt %, more particularly in the range from 0.1 to 1.5 wt % and especially in the range from 0.1 to 1 wt %.

The advantages of the invention are also manifested especially when the potassium chloride has not been formulated with free flow aids or contains only small fractions of free flow aids, where in these cases the free flow aid content typically does not exceed 0.1 wt %, especially 0.05 wt %, based on the total mass of the potassium chloride.

Preferably, in the case of stored potassium chloride in which caking has occurred, at least the caked fractions of the stored potassium chloride are ground. This does not mean that all caked fractions of the entire potassium chloride in a store are necessarily subjected to grinding. Instead, the amount of potassium chloride in which it is desired to reduce the tendency toward caking is withdrawn from the store, and at least the caked fractions of this amount are subjected to grinding. Prior to grinding, for example, it is possible to remove the caked fractions from uncaked fractions, by sieving or air-classifying, for example, and then to subject the caked fractions to grinding. Alternatively, the caked fractions can be subjected to grinding together with uncaked fractions. Preferably at least 50%, more particularly at least 80%, and especially at least 90% of the amount of stored potassium chloride in which it is desired to reduce the tendency toward caking is subjected to grinding. For practical reasons, a frequent approach is to subject to grinding the entire amount of the stored potassium chloride in which the desire is to reduce the tendency toward caking. The ground potassium chloride can be put back into storage as it is. However, the ground potassium chloride can also be mixed with the unground, uncaked fraction of the stored potassium chloride, and put into storage again, without the success of the invention being lost.

Immediately after their production, the solid forms of the potassium chloride, i.e., not only potassium chloride in crystal form but also pellets and compacted granules, typically have an increased temperature, which frequently is more than 50° C., This material, still hot, is typically put into storage directly, or packaged and put into storage. To reduce the caking tendency it has proven advantageous if the grinding of the potassium chloride or of the caked fractions of the potassium chloride is carried out no earlier than when the potassium chloride, still hot after production, has cooled to an extent such that it is at ambient temperature or almost ambient temperature. The potassium chloride or the caked fractions of the stored potassium chloride will preferably be passed for grinding no earlier than when it has a temperature of not more than 5 K above the ambient temperature or its temperature deviates by not more than 5 K from the ambient temperature. The potassium chloride passed to grinding has typically reached the temperature of not more than 5 K above the ambient temperature or a temperature which deviates by not more than 5 K from the ambient temperature after about 3 days, but no later than after 7 days following its production.

The potassium chloride passed for grinding typically has a temperature of not more than 35° C.

Immediately after their production, the solid forms of the potassium chloride, i.e., not only potassium chloride in crystal form but also pellets and compacted granules, typically still have a residual moisture content when they are put into storage. After a certain storage time, this residual moisture content attains a constant or at least nearly constant final value, which in general fluctuates not more than 10%, based on the actual final value. For reducing the caking tendency it has proven advantageous if the grinding of the potassium chloride or of the caked fractions of the stored potassium chloride is carried out no earlier than when the moisture contained in the potassium chloride as an inevitable concomitant of production has dropped to the constant or near-constant final value. The moisture contained in the potassium chloride as an inevitable concomitant of production has dropped to the constant or near-constant final value typically after about 3 days, but no later than after 7 days following its production.

Accordingly, the potassium chloride will be passed for grinding preferably no earlier than 3 days, more particularly no earlier than 7 days, after its production.

The advantages of the invention are also manifested especially when the moisture content of the potassium chloride does not exceed a level of 2 wt %, more particularly 1 wt %, determined by ascertainment of the loss on drying at 105° C. In particular, prior to the grinding, the potassium chloride has a moisture content of 0.02 to 2 wt %, especially 0.05 to 1 wt %, determined by ascertainment of the loss on drying at 105° C. This loss on drying is determined typically in a method based on DIN EN 12880:2000, by drying a sample of the potassium chloride to constant weight under ambient pressure at temperatures in the range of 105±5° C., Laboratory drying for the purpose of determining the loss on drying takes place generally in a drying oven. The time needed to achieve constant weight in the case of potassium chloride products is typically below 2 h. In this case, the dry residue in %, based on the starting weight employed, is ascertained by weighing before and after drying. The loss on drying in % is obtained from the dry residue in % by subtraction from 100.

As already elucidated above, the purpose of grinding the potassium chloride, especially stored potassium chloride or the caked fractions present in stored potassium chloride, is to disrupt the agglomerates, i.e., for deagglomeration, and therefore leads to an improved flowability or capacity for free flow on the part of the potassium chloride. After the potassium chloride thus treated has been put into storage, surprisingly, reformation of agglomerates occurs to a very much lower degree, and so the treatment significantly reduces the caking tendency.

Grinding may be carried out in a conventional way, with the use, for example, of customary apparatus for deagglomerating or comminuting of solid saltlike products. Typical devices for this purpose are crushers, e.g., jaw crushers, roll crushers, especially those having spiked rolls, or impact crushers, and also impact mills.

The grinding is preferably carried out such that the grain size distribution remains substantially unchanged in comparison to the freshly produced product or the product prior to storage; in other words, there is primarily achievement of deagglomeration of the caked grains, without the grains as such being significantly destroyed. This is accomplished by controlling the energy input and the grinding time or residence time in the grinding device in a manner known per se. The required parameters can be determined by the skilled person by means of routine experiments.

The grinding, accordingly, will be carried out in such a way that the x_{50,3} value (median) of the grain size distribution of the potassium chloride, determined by sieve analysis according to DIN 66165:2016-08, after grinding deviates not more than 10%, more particularly not more than 5%, and especially not more than 3% from the x_{50,3} value of the particle size distribution of the potassium chloride prior to being placed into storage, or of the freshly produced potassium chloride. Preferably the grinding will be carried out in such a way that the x_{90,3} value (median) of the grain size distribution of the potassium chloride, determined by sieve analysis according to DIN 66165:2016-08, after grinding deviates not more than 20%, more particularly not more than 10%, and especially not more than 5% from the x_{90,3} value of the particle size distribution of the potassium chloride prior to being placed into storage, or of the freshly produced potassium chloride. In particular the grinding will be carried out in such a way that no notable fractions of small-particle material are formed. In particular the x_{10,3} value (median) of the grain size distribution of the potassium chloride, determined by sieve analysis according to DIN 66165:2016-08, after grinding is to deviate not more than 20%, especially not more than 10%, from the x_{10,3} value of the particle size distribution of the potassium chloride before being placed into storage, or of the freshly produced potassium chloride. Accordingly, the potassium chloride obtained after grinding has grain sizes which are in the range from 0.01 to 50 mm. In particular at least 90 wt % of the ground potassium chloride has a grain size in the range from 0.01 to 5 mm, especially in the range from 0.05 to 1 mm, determined by sieve analysis according to DIN 66165:2016-08. The average grain size (weight average or the d_{50,3} value) of the ground potassium chloride is in the range from 20 μm to 300 μm, more particularly in the range from 20 μm to 800 μm.

In the experiments below, the following potassium chloride materials were investigated in respect of their tendency toward caking:

Experiment 1:

Potassium Chloride 1:

Unformulated potassium chloride having the following specification:

KCl content of 99.1 wt % (=61% K₂O).

Total Ca+Mg content around 0.01 wt %.

Loss on drying at 105° C. about 0.1 wt %.

>90 wt % of the particles have the following grain size distribution:

x_{10,3}=9.84 μm

x_{50,3}=35.50 μm

x_{90,3}=93.58 μm

Experiment 2:

Potassium Chloride 2:

Unformulated potassium chloride having the following specification:

KCl content of 95 wt % (=59.9% K₂O).

Total Ca+Mg content around 0.5 wt %.

Loss on drying at 105° C. about 0.1 wt %.

<90 wt % of the particles have a grain size in the range greater than 500 μm.

Experiment 3:

Potassium Chloride 3:

Unformulated potassium chloride having the following specification:

KCl content of 99.99 wt %.

Total Ca+Mg: 0 wt %.

Loss on drying at 105° C. below 0,01 wt %.

<90 wt % of the particles have a grain size in the range greater than 1 mm.

Experiment 4:

Potassium Chloride 4:

Unformulated potassium chloride having the following specification:

KCl content of 95.9 wt % (=60.6% K₂O).

Loss on drying at 105° C. about 0.09 wt %.

<90 wt % of the particles have a grain size in the range greater than 500 μm.

With the exception of potassium chloride 1, the grain size distribution was determined on an analytical sieve shaker machine (Retsch AS 200 control). The grain size distribution of potassium chloride 1 was determined by laser light diffraction according to ISO 13320:2009, using, for example, a Mastersizer 200 from Malvern.

The caking values were determined in a caking value tester.
(1) For determining the caking tendency, samples of the potassium chloride (about 200 g) were placed into cylindrical steel vessels having an internal diameter of 5.6 cm. The filled hollow cylinder was then closed by means of a die having a circular head surface. The die was loaded with a force of 400 N and the sample was left under this loading for 7 d at ambient temperature (22° C.). This simulates storage in a heap and forces more or less severe caking of the sample.
(2) The die was subsequently unloaded. A testing press drives a rounded conical test die (opening angle 30°, tip radius 3 mm) into the caked heap. The force expended is recorded as a function of the penetration depth. The force required for the penetration rises in approximately linear proportion to the penetration depth. The experiment was ended at a penetration depth of 5 mm or a force of 800 N, or on fracture of the test specimen. The data thus obtained were analyzed by linear regression in order to ascertain the ratio of force to penetration depth (m). The values for 5 measurements each, and the standard deviation σ, are reported in table 1 (values before deagglomeration).
(3) The sample was subsequently manually broken up and deagglomerated, and again as described under (1) was placed into a cylindrical steel vessel, which was closed by means of a die having a circular head area. The die was again loaded with a force of 400 N and the sample was left with this loading for 7 d at ambient temperature (22° C.). The force needed for the test die to penetrate the sample thus generated was then ascertained by the method described under (2). The results are likewise compiled in table 1 (values after deagglomeration). The samples after deagglomeration continually exhibit deformation or breaking phenomena of the heap during penetration of the test specimen. From this it is possible to derive whether preparation according to the invention leads to lower resistance forces in the heap (lower values for the force required for penetration in the case of the samples after deagglomeration). The solid bridges are broken mechanically, and so even renewed storage does not lead to formation of bridges. As a result, the material is free-flowing and relatively easy to break up, and brings distinct advantages during the management of the material.
(4) For determining the particle size distribution after deagglomeration, a loaded sample was produced as described under (1) and was subsequently manually broken up and deagglomerated. The data are compiled in table 2. The calculated parameters (with linear integration) for samples before and after deagglomeration show no great deviation. It can therefore be assumed that the changes in the caking behavior occur independently of the size distribution of the material.

TABLE 1

| Potassium | before deagglomeration | | after deagglomeration | |
|---|---|---|---|---|
| chloride | m [N/mm] | σ | m [N/mm] | σ |
| 1 ¹⁾ | 156.6 | 5.6 | 29.6 | 6.4 |
| 2 ¹⁾ | 135.6 | 34.4 | 12.8 | 3.0 |
| 3 ¹⁾ | 104.6 | 3.8 | 90.9 | 2.8 |
| 4 ¹⁾ | 33.9 | 2.9 | 3.35 | 0.8 |

¹⁾ Loading with 400N immediately after its production

TABLE 2

| | | |
|---|---|---|
| | Particle size before | Particle size after |
| Potassium | deagglomeration | deagglomeration |

| chloride | x_{10.3} | x_{50.3} | x_{90.3} | x_{10.3} | x_{50.3} | x_{90.3} |
|---|---|---|---|---|---|---|
| 1 | 9.84 | 35.50 | 93.58 | 9.19 | 34.76 | 89.49 |
| | μm | μm | μm | μm | μm | μm |

1. A method for reducing a caking tendency of potassium chloride during storage thereof, the method comprising:
inducing caking of potassium chloride grains in a potassium chloride to produce a caked potassium chloride,
grinding the caked potassium chloride to produce a ground potassium chloride, and
subsequently storing the ground potassium chloride.

2. The method as claimed in claim 1, wherein the caking is induced by exerting compressive pressure on the potassium chloride grains.

3. The method as claimed in claim 1, wherein the caking is induced by storing the potassium chloride grains.

4. The method as claimed in claim 3, wherein at least caked fractions of a stored potassium chloride are passed to grinding and the ground potassium chloride is subsequently put into storage again or mixed with an unground fraction of the stored potassium chloride and put into storage again.

5. The method as claimed in claim 4, wherein a total amount of the stored potassium chloride is subjected to grinding.

6. The method as claimed in claim 1, wherein at least 90 wt % of the potassium chloride grains, prior to the caking, has a grain size in the range from 0.01 to 5 mm, determined by sieve analysis according to DIN 66165:2016-08,

7. The method as claimed in claim 1, wherein the x_{50,3} value (median) of a grain size distribution of the ground potassium chloride, determined by sieve analysis according to DIN 66165:2016-08, deviates not more than 10% from an x_{50,3} value of a grain size distribution of the potassium chloride grains prior to the caking.

8. The method as claimed in claim 1, wherein at least 90 wt % of the ground potassium chloride has a grain size in the range from 0.01 to 5 mm, determined by sieve analysis according to DIN 66165:2016-08.

9. The method as claimed in claim 1, wherein the grinding is carried out no earlier than when the potassium chloride, still hot after production, has cooled such that the potassium chloride has a temperature of not more than 5 K above the ambient temperature.

10. The method as claimed in claim 1, wherein the grinding is carried out no earlier than when the moisture contained in the potassium chloride as an inevitable concomitant of production has dropped to a constant or near-constant final value.

11. The method as claimed in claim 1, wherein the potassium chloride, prior to the grinding, has a moisture content of 0.02 to 2 wt %, determined by ascertaining a loss on drying at 105° C.

12. The method as claimed in claim 1, wherein the potassium chloride is passed to grinding no earlier than 3 days after the potassium chloride has been produced.

13. The method as claimed in claim 1, wherein the potassium chloride has a KCl content of at least 95 wt %.

14. The method as claimed in claim 1, wherein the potassium chloride is in a form of crystals.

15. The method as claimed in claim 1, wherein the potassium chloride contains less than 0.1 wt % of an anticaking agent.

16. The method as claimed in claim 7, wherein x_{50,3} value of the grain size distribution of the ground potassium chloride, determined by sieve analysis according to DIN 66165:2016 08, deviates not more than 5% from the x_{50,3} value of the grain size distribution of the potassium chloride grains prior to the caking.

17. The method as claimed in claim 16, wherein the x_{50,3} value of the grain size distribution of the ground potassium chloride, determined by sieve analysis according to DIN 66165:2016 08, deviates not more than 3% from the x_{50,3} value of the grain size distribution of the potassium chloride grains prior to the caking.

18. The method as claimed in claim 12, wherein the potassium chloride is passed to grinding no earlier than 7 days after the potassium chloride has been produced.

19. The method as claimed in claim 13, wherein the KCl content of the potassium chloride is in the range from 98 to 99.9 wt %.
